(19) United States
(12) Patent Application Publication
(10) Pub. No.: US 2012/0012683 A1
(43) Pub. Date: Jan. 19, 2012

(54) WATERING DEVICE FOR AN INDIVIDUAL PLANT CONTAINER

(75) Inventor: Carl E. Whitcomb, Stillwater, OK (US)

(73) Assignee: LACEBARK, INC., Stillwater, OK (US)

(21) Appl. No.: 12/835,828

(22) Filed: Jul. 14, 2010

(51) Int. Cl. B05B 1/14

(52) U.S. Cl. 239/548

(57) ABSTRACT

A watering device includes a cover, support members, and a water nozzle secured to the underneath side of cover. The water nozzle directs water outward along the first side of the cover to distribute water across the top surface of the plant growth medium in a nursery plant container. A desired water deflection pattern may optionally be achieved using one or more water deflectors secured to the underneath side of the cover in a position within a water distribution pattern of the water nozzle. The cover may include an open slot allowing the cover to be placed about the stem of a plant growing in the container and set on the top surface of the plant growth medium.

### BACKGROUND

1. Field of the Invention

The present invention relates generally to devices for watering a plant, and more particularly to devices for watering a plant growing in an individual container.

2. Background of the Related Art

Plant nurseries produce large numbers of plants, typically in temporary containers that allow the plants to grow to a size suitable for planting into a landscape. As with any plant, these plants must receive an appropriate amount of water. Depending upon the size of the nursery and perhaps the range of plant varieties and conditions, these individually containerized plants may be watered by hand using a hose and spray nozzle, by an overhead or area sprinkler system, or by individual spray nozzles (spray stakes) positioned at each of the plants. Watering by hand can be very labor intensive and the use of large area sprinkler systems can lead to significant water losses since much of the water does not end up in the containers.

Many nurseries now deliver water to their containerized plants on a container-by-container basis to conserve water, either to save on water costs or to meet local water conservation regulations. Spray stakes are designed for an irrigation system of this type. A spray stake has a sharp stake end that is pushed into the plant growth medium within the container in order to position a spray structure above the top surface of the medium. The spray structure is coupled to a small water supply tube. As water is released from the tube, a spray pattern distributes water across the top surface of the medium within the container. However, the sprays stake may easily tilt out of position as a result of bumping the container or tugging on the tube. When the stake tilts, the spray structure is no longer accurately directed over the top of the medium and may spray water outside the container. Likewise, if a portion of the container growth medium does not receive water, no roots grow in that area and plant growth is restricted. Accordingly, a spray stake may not reliably conserve water as intended. Furthermore, even a properly oriented spray stake produces a spray pattern that is subject to wind conditions that may cause a significant loss of water.

### BRIEF SUMMARY

One embodiment of the present invention provides a watering device comprising a cover that extends over a portion of the surface of container growth medium and a water nozzle secured to the cover. The cover has at least one support member secured to a first side of the cover to support the cover in a position that is a spaced distance above a plant growth medium. The water nozzle is positioned along the first side of the cover and has an inlet for coupling to a water supply tube and an outlet directing water outward from the nozzle along the first side of the cover. The watering device is suitable for use in a nursery plant container to distribute water across the top surface of the plant growth medium.

In another embodiment of the present invention, the water nozzle comprises a nozzle body having a plug with a terminal end for insertion into a water supply tube, and a water supply groove formed in the plug and longitudinally extending along a side of the plug from the terminal end. The water supply groove branches into a plurality of water distribution grooves formed in a side of the nozzle body, wherein each water distribution groove has an open end for releasing a water stream.

In a still further embodiment of the present invention, the water nozzle comprises a nozzle body having a plurality of plugs, each plug having a terminal end for insertion into a water supply tube and a water supply groove longitudinally extending along a side of the plug from the terminal end. Each water supply groove branches into a plurality of water distribution grooves formed in a side of the nozzle body, wherein each water distribution groove has an open end for releasing a water stream. Furthermore, each water supply groove has a different cross-sectional area for supplying a different amount of water from the water supply tube. Optionally, the nozzle body includes a water shut-off plug having a terminal end for insertion into the water supply tube, wherein the water shut-off plug prevents water flow from the water supply tube.

### BRIEF DESCRIPTION OF THE SEVERAL VIEWS OF THE DRAWINGS

FIG. 1 is a perspective top view of a watering device according to one embodiment of the present invention in its operable position in a nursery plant container.

FIG. 2 is a perspective bottom view of the watering device.

FIG. 3 is a perspective bottom view of the watering device with the water nozzle disconnected from the cover.

FIG. 4 is a bottom plan view of the watering device showing the water distribution pattern from the water nozzle and from the water deflection pattern.

FIG. 5 is a cross-sectional side view of the watering device in its operable position in a nursery plant container.

FIG. 6 is a blow up of one portion of the cross-sectional side view of FIG. 5, illustrating the functioning of the water supply groove in the water nozzle.

FIG. 7 is a top perspective view of a water nozzle having a water supply groove and a plurality of water distribution grooves.

FIG. 8 is a bottom perspective view of water nozzle having a plurality of selectable plugs for altering the water flow rate.

FIG. 9 is a bottom perspective view of a water nozzle having two selectable plugs each having a water supply groove for altering the water flow rate, wherein water distribution grooves or ribs are permanently formed as part of the cover.

FIG. 10 is a partial perspective view of a bracket 90 secured to the underneath side of a cover.

### DETAILED DESCRIPTION

One embodiment of the present invention provides a watering device comprising a cover and a water nozzle secured to the cover. The cover has at least one support member secured to a first side of the cover to support the cover in a position that is a spaced distance above a plant growth medium. The water nozzle is positioned along the first side of the cover and has an inlet for coupling to a water supply tube and an outlet directing water outward from the nozzle along the first side of the cover. The watering device is suitable for use in a nursery plant container to distribute water across the top surface of the plant growth medium.

The cover may have various configurations, but is preferably planar. The support member(s) that holds the cover above the plant growth medium may be disposed along a perimeter edge of the cover, distributed over the surface area of the first side of the cover, or establish some other configuration for supporting the cover. The purpose of the support members is to create space between the plant growth medium and the cover where the water nozzle spray water over a substantial portion of the plant growth medium. Preferred configurations of the support members should achieve the objective of supporting the cover without disturbing the intended distribution of water. In one preferred configuration, the at least one support member(s) includes a plurality of ribs generally radially aligned with a water distribution pattern of the water nozzle.

The water nozzle has an outlet that directs water along the first (underneath) side of the cover and releases the water outwardly under a high pressure. Accordingly, the water is sprayed from the nozzle at a spaced distance above the plant growth medium and is directed outwardly under force. Desirably, the water is distributed over a substantial portion of the plant growth medium before the water drops downward into contact with the medium. Optionally, the water pathways leading from the water nozzle may be described as having an “aspect ratio” defined by the ratio of the water pathway length to height. The length of the water pathway is the linear distance that the water can travel away from the water nozzle outlet before dropping into the medium. The height of the water pathway is the generally established by the height of the support members. For example, a cover having a diameter of about 8 inches may have a nozzle that sprays water over a 6 inch distance under a cover that is supported only ½ inch above the medium. Such a pathway could be described as having an aspect ratio of 12 (6 inches/0.5 inches). A particular water distribution pattern may direct water over several different water pathways having the same or different aspect ratios. An optional range of aspect ratios is between 2 and 20.

In a further embodiment, the watering device includes one or more water deflectors secured to the first side of the cover in a position within a water distribution pattern of the water nozzle. The deflector is an open surface that deflects water that is directed at the deflector from the water nozzle. Optionally, the watering device may include a plurality of water deflectors secured to the first side of the cover. Each water deflector preferably has a leading edge directed toward the water nozzle and positioned within a water distribution pattern of the water nozzle, as well as surface that deflects water from the water nozzle in an outward direction toward a perimeter of the cover. In a first option, the leading edge of each water deflector comes to a point. In a second option, one or more of the water deflectors has a distal end that is flared outwardly to form an outwardly directed water stream. In a further option, the plurality of water deflectors includes from 3 to 12 deflectors, or from 5 to 9 deflectors.

In another embodiment, the cover has an open slot that extends from the edge of the cover toward the center of the cover for receiving a plant stem. The open slot allows the cover to be positioned about a plant stem, or removed from a position about a plant stem, without disturbing the plant. Furthermore, a single cover can be used to distribute water over a substantial portion of the medium.

In a still further embodiment, the water nozzle comprises a nozzle body having a plug with a terminal end for insertion into a water supply tube, and a water supply groove formed in the plug and longitudinally extending along a side of the plug from the terminal end. In a first option, the water supply groove branches into a plurality of water distribution grooves formed in a side of the nozzle body, wherein each water distribution groove has an open end for releasing a water stream. In a second option, the plurality of water distribution grooves is formed in the first side of the cover in alignment with the water supply groove in the water nozzle. In either option, it is preferable that the plurality of water distribution grooves diverge in order produce a water distribution pattern. A water distribution pattern may include a wide-angle spray of water, or a plurality of individual water streams angled away from each adjacent stream.

In a still further embodiment of the present invention, the water nozzle comprises a nozzle body having a plurality of plugs, each plug having a terminal end for insertion into a water supply tube and a water supply groove longitudinally extending along a side of the plug from the terminal end. Each water supply groove branches into a plurality of water distribution grooves formed in a side of the nozzle body, wherein each water distribution groove has an open end for releasing a water stream. Furthermore, each of the plugs are preferably similarly sized for insertion into a common size of water supply tube, although the water supply groove in each plug will preferably have a different cross-sectional area for supplying a different amount of water from the water supply tube. Optionally, the nozzle body includes a water shut-off plug having a terminal end for insertion into the water supply tube, wherein the water shut-off plug prevents water flow from the water supply tube. The nozzle body is preferably selectively securable with any one of the plurality of plugs adjacent the cover. Accordingly, coupling the water supply tube to a particular plug will determine the water flow rate, yet the nozzle body may be secured with the particular plug positioned adjacent the surface of the cover.

Each of the plurality of plugs extending from the nozzle body will have a water supply groove (except for a water shutoff plug). As with embodiments having a single plug, each water supply groove may branch into a plurality of water distribution grooves formed in a side of the nozzle body, wherein each water distribution groove has an open end for releasing a water stream. Alternatively, the nozzle body is selectively securable to the cover to position the water supply groove of any one of the plurality of plugs in alignment with a plurality of water distribution grooves formed in the first side of the cover.

The water distribution grooves are preferably “V-shaped” for convenience of manufacture and resist plugging. However, the water distribution grooves may have different shapes or profiles, and it is not necessary for each groove to have the same shape or size. Presently preferred embodiments have from 3 to 5 water distribution grooves. In one option, there may be two larger V-shaped grooves on either side of center, and one smaller groove in the center. One of the larger grooves may be directed to a deflector that turns the water direction outwardly by 90-120 degrees.

In a further embodiment, the water nozzle may be used independent of the cover. The nozzle body makes the water nozzle selectively securable to other structural elements, such as the side of a plant container. Preferably, such a container or other structure will be adapted with a slot or bracket for receiving and securing the nozzle body. With the water nozzle secured in this manner, the nozzle orientation will be fixed so that bumping the container or the nozzle does not change the direction of the water distribution. Unfortunately, such an embodiment would be without a cover and the water distribution pattern would be subject to the wind, but it would be cheaper to make. Furthermore, if the water nozzle is attached to a stake that inserts against the inside of a container, the water nozzle position and orientation would be much more stable and stationary compared to other spray stakes on the market. Still further, if the water nozzle is secured to a spray stake having a hook on one side, then the spray stake could be inserted deep into the plant growth medium with the hook extending over the lip of the pot for lateral and elevational support.

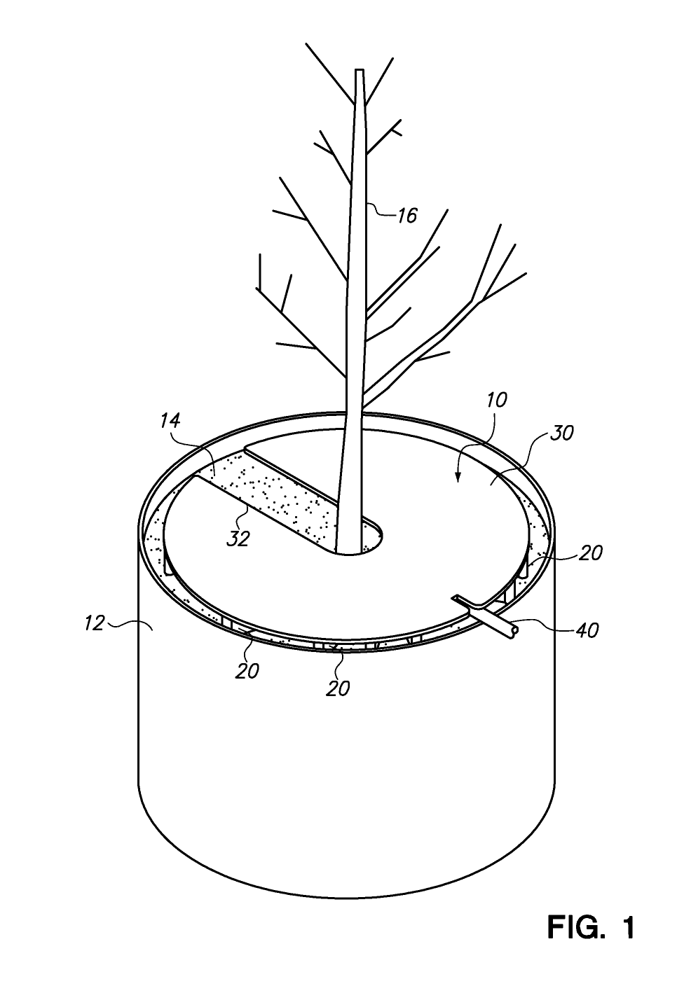

FIG. 1 is a perspective top view of a watering device 10 according to one embodiment of the present invention in its operable position in a nursery plant container 12. The plant container 12 is substantially filled with a plant growth medium 14, such as soil, so that a plant 16 may grow in the container. The watering device 10 may be positioned to lay over the plant growth medium 14 with support members 20 holding a flat cover 30 a spaced distance above the plant growth medium 14. An open slot in the cover 30 allows the watering device to be positioned about the stem of the plant 16. Components discussed below enable a water supply tube 40 to deliver water to a nozzle (not shown) for distribution over a substantial portion of the surface of the plant growth medium 14.

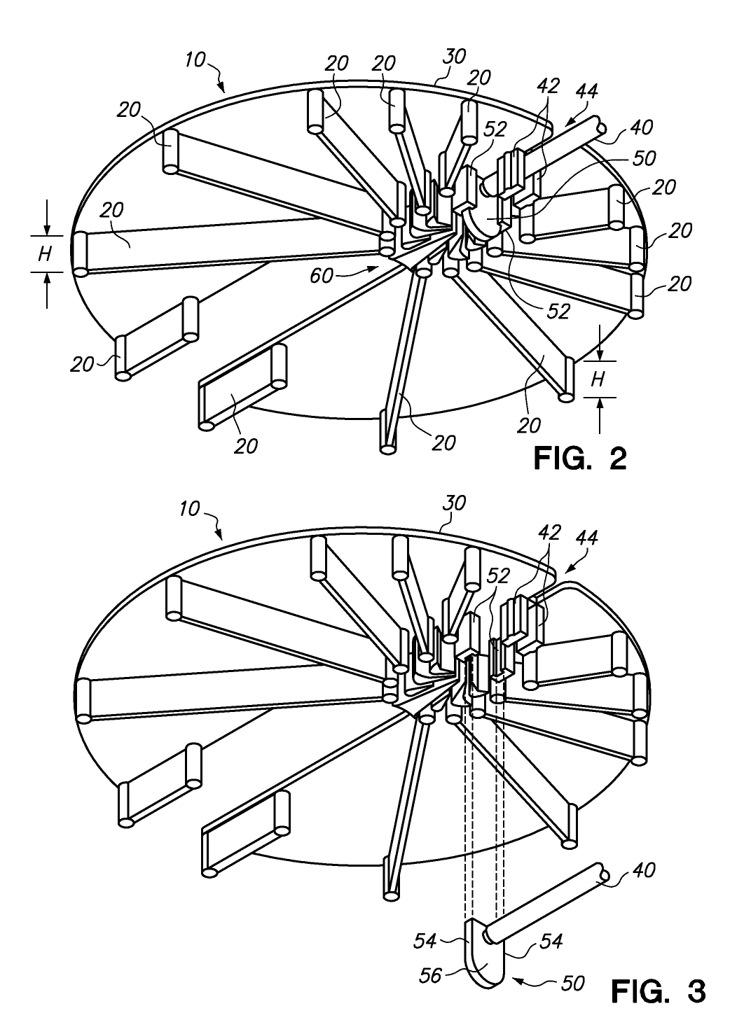

FIG. 2 is a perspective bottom view of the watering device 10. The bottom or underneath side of the cover 30 shown, faces the plant growth medium (see medium 14 in FIG. 1) during use. Accordingly, the support members 20 may be described and downwardly extending to support the cover 30 a spaced distance H above the plant growth medium. Although the support members 20 may participate in directing the distribution of water, the primary function of the support members is the supporting the cover 30 above the plant growth medium to created a protected space between the cover and the medium for the distribution of water. The cover, and perhaps also the support members, prevents wind from carrying away or misdirecting water as it is sprayed over the plant growth medium. Furthermore, the broad area of the plant growth medium that is contacted by the support members 20 keeps the cover in a stable position that is generally parallel to the plant growth medium. Preferably, the watering device 10 has a very low profile to avoid catching wind. For example, the watering device 10 shown in FIG. 2 has an overall shape that may be referred to as a disk.

The watering device 10 also includes a water nozzle 50 secured to the underneath side of the cover 30, such as a pair of side brackets 52 selectively securing the nozzle body. The water nozzle 50 releases water from the water supply tube 40 along the underneath side of the cover 30 toward a plurality of deflectors 60. Although the water nozzle may have its own divergent water distribution pattern, as discussed in greater detail below, deflectors 60 may be used to achieve a water deflection pattern that covers an even broader area of the plant growth medium. Optionally, the water supply tube 40 extends between a pair of stabilizing brackets 42 to prevent the tube from putting torque on the water nozzle. Furthermore, the cover 30 includes a slot 44 that allows the tube 40 to bend upward through the cover 30, for example so that the tube can rise over the rim of the plant container without lifting the cover.

FIG. 3 is a perspective bottom view of the watering device 10 with the water nozzle 50 disconnected from the cover 30. The opposing sides 54 of the nozzle body 56 are selectively securable between the pair of side brackets 52. The brackets 52 are each shown with a channel for receiving the sides 54. The water nozzle 50 is preferably secured to the brackets 52, as shown in FIG. 2, by friction arising in part due to the elastic deformation of the brackets 52 when the nozzle body 56 is inserted therein.

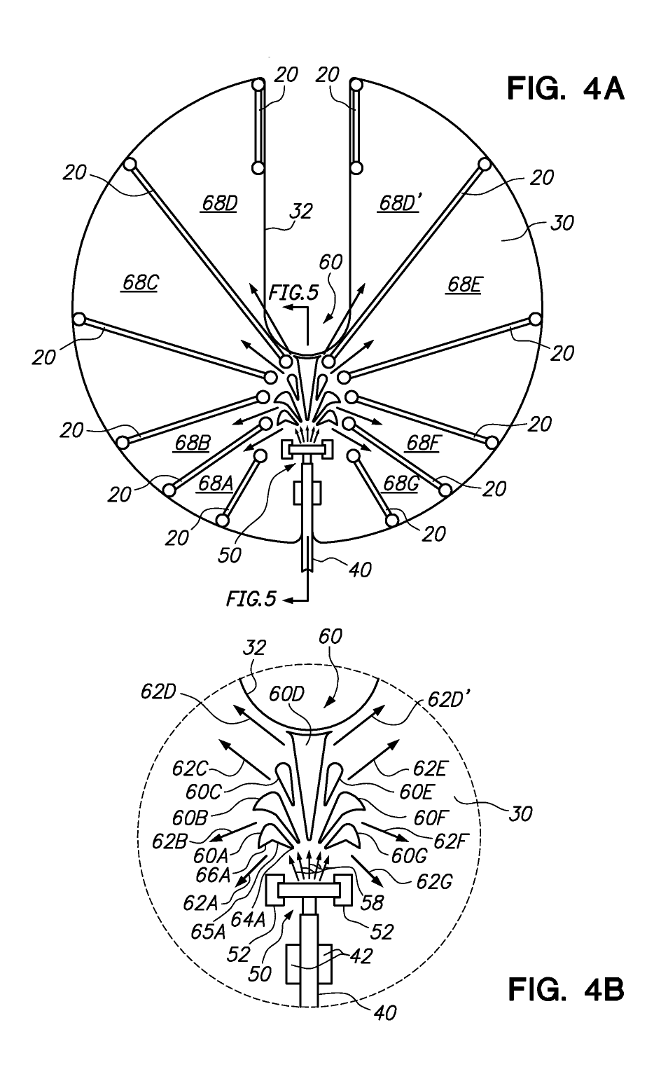

FIG. 4A is a bottom plan view of the watering device 10. The water nozzle 50 directs water toward the plurality of deflectors 60. The number of deflectors may vary, but seven deflectors 60 are shown having a leading edge disposed within the water distribution pattern of the water nozzle 50. The lead edge of each deflector preferably comes to a point in order to split off a water stream without blocking any significant portion of the water. The trailing surface of each deflector is largely determinative of the direction of the deflected water stream. Accordingly, the plurality of deflectors 60 may each have a trailing surface that directs water to a different portion of the area under the cover 30. As shown, the trailing surface of each deflector directs water outwardly toward the perimeter of the cover.

Where the support members 20 are disposed in a substantially radial pattern relative to the deflectors 60, the deflectors 60 will each preferably direct a water stream to avoid hitting the inner-most edge of the support members. Still, it is not critical to have a water stream between each pair of adjacent support members, and it is not critical to have a support member between each pair of adjacent water streams. In fact, it is intended that the support members 20 hold the cover 30 a spaced distance above the plant growth medium without interfering with the desired distribution of the water. In another embodiment, each of the radial support members 60 may be replaced by support members disposed around the perimeter of the cover.

FIG. 4B is an enlarged bottom plan view of a portion of the watering device 10 in FIG. 4A highlighting the relationship between the water nozzle 50 and the deflectors 60. In particular, the water distribution pattern (arrows 58 collectively) from the water nozzle 50 is directed at the deflectors 60A-G, which form the water deflection pattern (arrows 62A-G collectively). While each of the deflectors 60A-G have a leading edge that comes to a point, the trailing surface deflects water outwardly toward the perimeter edge of the cover 30. For example, the deflector 60A has a leading edge 64A that is disposed within the water distribution pattern 58. The water directed from the water nozzle 50 to the left of the leading edge 64A, will move along the leading surface 65A before being deflected by the trailing surface 66A. The trailing surface 66A is angled at almost 90 degrees from the leading surface 65A (or almost 120 degrees from the angle at which the water is received from the water nozzle). Accordingly, the deflector 60A deflects water over the plant growth medium that is below region 68A (See FIG. 4A). As shown, the seven deflectors 60A-G form at least eight water streams 62A-G (including 62D′) directed into different regions 68A-G (See FIG. 4A) of the cover 30. It should be recognized from this description that the number of deflectors may be varied and the angles at which the deflectors direct water may also be varied so as to produce a desired water deflection pattern.

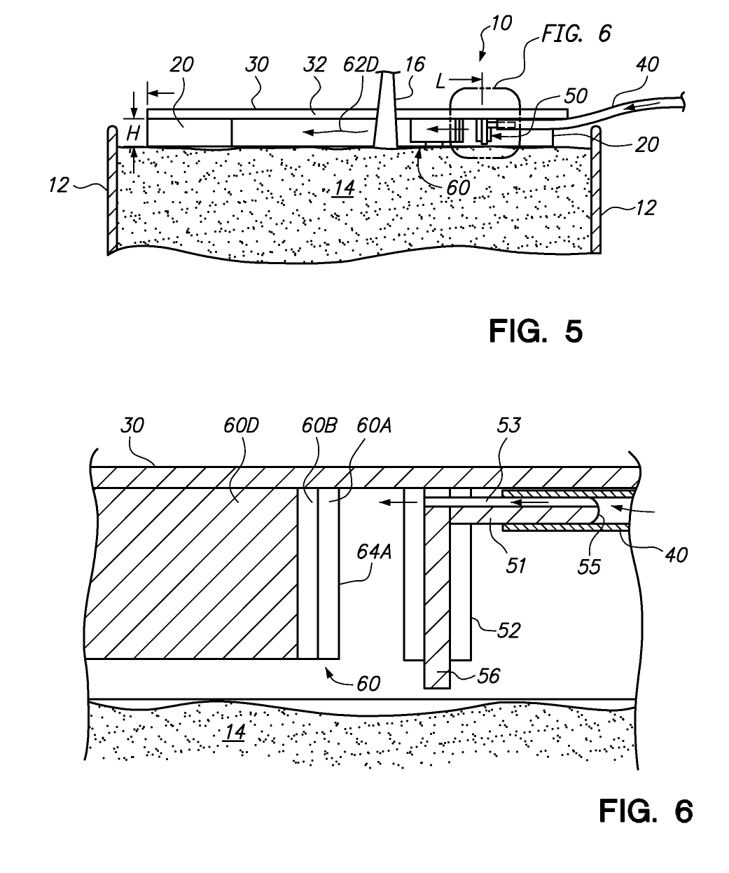

FIG. 5 is a cross-sectional side view of the watering device 10 in its operable position in a nursery plant container 12 consistent with FIG. 1, as taken along the section line in FIG. 4A. The cover 30 extends over a substantially portion of the surface of the plant growth medium 14 with the plant stem 16 received within the slot 32. Support members 20 support the cover 30 a spaced distance H above the exposed surface of the plant growth medium 14 forming an open spaced between the cover and the medium for the distribution of water. The water supply tube 40 provides water under pressure to the water nozzle 50, which releases the water toward the plurality of deflectors 60. The water continues outwardly, as directed by the deflectors, but over a distance L from the nozzle the water will lose elevation (as illustrated by the downwardly arched arrow 62D) until it ultimately comes into contact the top surface of the plant growth medium. From there the water will flow into the plant growth medium as described by Darcy's law of fluid flow through a porous medium. The ratio of L/H may be describes as an aspect ratio of the water pathway. Such an aspect ratio may be determined for a deflected pathway as the sum of the distance from the nozzle to the deflector and the distance from the deflector to the perimeter of the cover. In a similar manner, the watering device itself may be described as having an aspect ratio defined by a width dimension W (such as a diameter) divided by the height H. The watering device preferably has an aspect ratio from 5 to 30, and more preferably from 10 to 20, to keep the cover close to the plant growth medium and avoid wind effects. In one non-limiting example, a watering device may have a diameter of about eight inches and have support members of about one half inch in height, such that the device has an aspect ratio of about sixteen.

FIG. 6 is a blow up of one portion of the cross-sectional side view of FIG. 5, illustrating the functioning of the water nozzle 50. The water nozzle 50 includes the nozzle body 56 that is selectively secured to the brackets 52 on the underneath side of the cover 30. The nozzle body 56 includes a plug 51 having a proximal end immediately adjacent an edge of the nozzle body 56 and a terminal end 55 that is received within the water supply tube 40. While the plug 51 is sized to fit snuggly within the tube 40, the plug 51 includes a water supply groove 53 along one side of the plug to form a pathway for water from the water supply tube 40 to be released in a direction defined by the groove. As shown, the water supply groove 53 is directed at the deflectors 60.

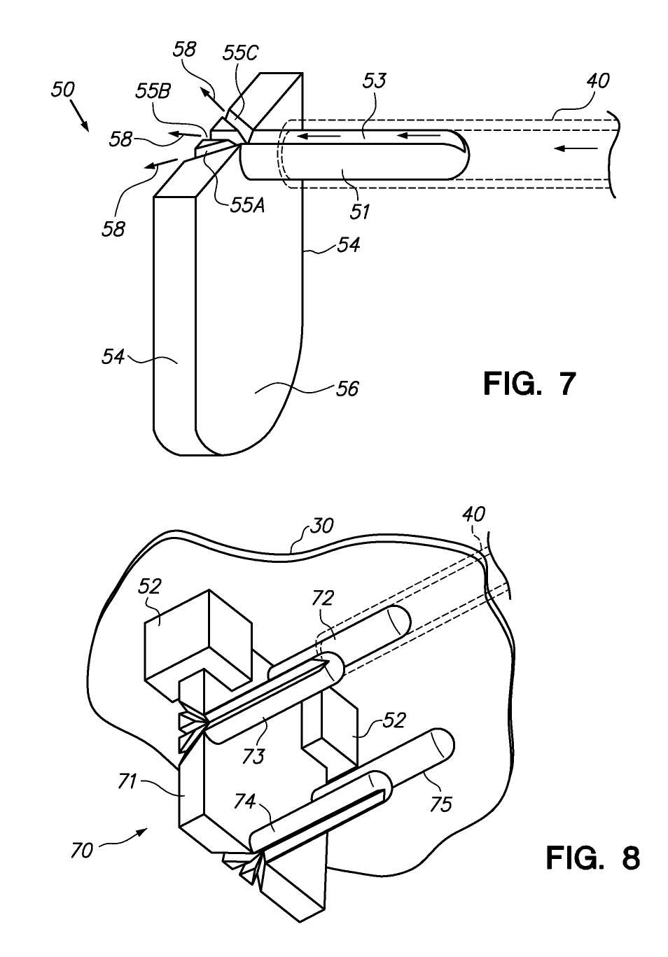

FIG. 7 is a top perspective view of the water nozzle 50 having a water supply groove 53 in direct fluid communication with three water distribution grooves 55A-C. In this configuration, water flows from the water supply groove 53 into the water distribution grooves 55A-C, and is then released from open ends of the water distribution grooves in a water distribution pattern 58 having a plurality of divergent water streams. As shown, the water distribution grooves are formed in an edge of the nozzle body 56 and the grooves include a central groove 55B (substantially aligned with the water supply groove 53) and two divergent grooves 55A, 55C. It should be recognized that the number, shape and size of the grooves may vary. However, the grooves are preferred over the use of one or more orifice, because the grooves can be easily unplugged.

FIG. 8 is a bottom perspective view of another embodiment of a water nozzle 70 having a nozzle body 71 including four selectable plugs 72-75 for altering the water flow rate. As shown, the nozzle body 71 is a square so that it can be secured in the brackets 52 with any of the four edges facing the underneath side of the cover 30. Three of the plugs 72-74 each have a water supply groove that is in communication with a plurality of water distribution grooves formed in the nozzle body 71. The details of an individual plug, water supply groove, and plurality of water distribution grooves are consistent with the description and illustration of nozzle 50 in FIG. 7. However, the grooves have different cross-sectional area in order to allow for a selected one of three different volumetric flow rates from a single water supply tube 40. The tube 40 is selectively secured to the selected plug and the nozzle body 71 is inserted into the brackets 52 with the edge that is associated with the selected plug facing the underneath side of the cover. A further plug 75 does not have a water supply groove, such that coupling the tube 40 to the plug 75 serves to shut off all water flow from the tube 40. It should be appreciated that the water nozzle 70 enables a plant nursery worker to select an appropriate water flow for a given plant and prevailing conditions without changing the nominal pressure in the water supply tube 40. Typically, the water supply tube 40 is just one branch of a much larger and more complicated water distribution system that provides individual water supply tubes to each of a large number of watering devices. The ability to alter the flow rate to each watering device facilitates the delivery of an appropriate amount of water regardless of differences in plant variety, size of plant, shade and the like.

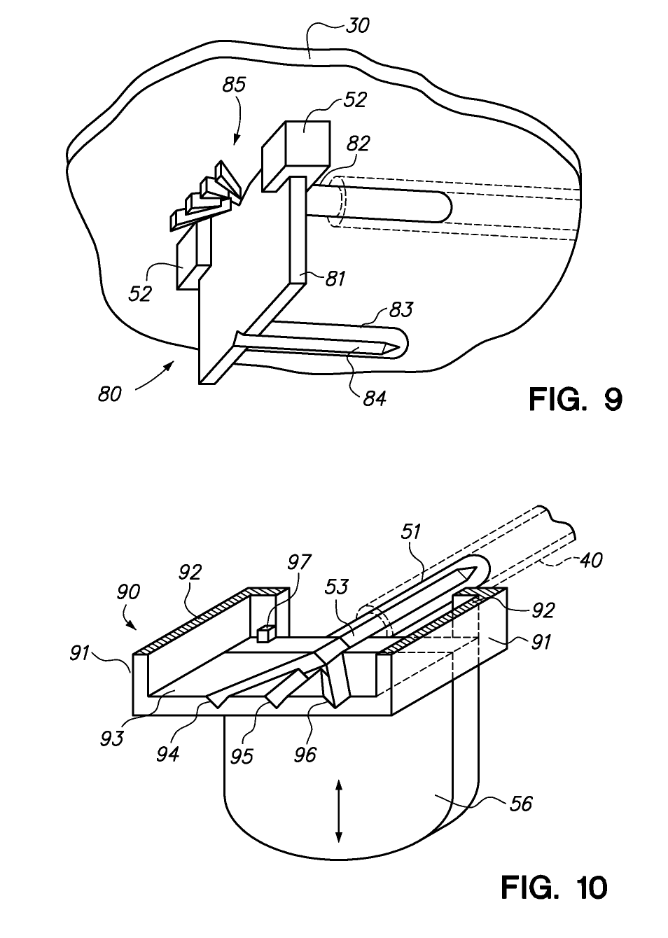

FIG. 9 is a bottom perspective view of a further embodiment of a water nozzle 80 with a nozzle body 81 having two selectable plugs 82-83 each having a water supply groove 84 for altering the water flow rate. In this embodiment, the water supply groove 84 continues from the plug across the edge of the nozzle body 81. Water distribution grooves or ribs 85 are permanently formed in the underneath side of the cover 30 in alignment with the water supply groove 84 so that water released from the groove 84 is angularly directed to produce the desired water distribution pattern. This embodiment of the water nozzle may simplify construction of the water nozzle. It should be recognized that this embodiment of the nozzle body may still include up to four plugs as shown in FIG. 8, except that the water distribution grooves shown in FIG. 8 are replace with a continuation of the water supply groove in the plug. It should also be recognized that the water distribution grooves may be formed in a separate component that is positioned within an injection mold as the remainder of the watering device is formed. The use of a separate component allows for water distribution grooves made to exact dimensions and tolerances. Furthermore, whether or not a separate component is used, the water distribution grooves may be formed in an upwardly facing manner.

FIG. 10 is a partial perspective view of a bracket 90 secured to the underneath side of a cover (not shown). The bracket 90 includes two side elements 91 secured to the cover along the cross-hatched surfaces 92 and a cross member 93 spaced apart from the cover. Upwardly facing water distribution grooves 94, 95, 96 are formed in the cross member 93. The water nozzle body 56 is selectively received by the bracket 90 so that the water supply groove 53 in the water nozzle plug 51 aligns with the water distribution grooves 94, 95, 96 in the bracket 90. Although the water distribution grooves are upwardly facing, the cross member 93 is spaced apart from the cover so that the grooves do not form an orifice that would be subject to plugging. An alignment element 97 may be provided to limit the insertion of the water nozzle body 56 and position the water supply groove 53 in alignment with the water distribution grooves.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A watering device, comprising:
a cover having at least one support member secured to a first side of the cover to support the cover in a position that is a spaced distance above a plant growth medium; and
a water nozzle coupled to the cover and positioned along the first side of the cover, the water nozzle having an inlet for coupling to a water supply tube and an outlet directing water outward from the nozzle along the first side of the cover.

2. The watering device of claim 1, wherein the at least one support member includes a plurality of ribs generally radially aligned with a water distribution pattern of the water nozzle.

3. The watering device of claim 1, further comprising:
one or more water deflectors secured to the first side of the cover in a position within a water distribution pattern of the water nozzle.

4. The watering device of claim 1, further comprising:
a plurality of water deflectors secured to the first side of the cover, each water deflector having a leading edge directed toward the water nozzle and positioned within a water distribution pattern of the water nozzle, wherein each water deflector has a surface that deflects water from the water nozzle in an outward direction toward a perimeter of the cover.

5. The watering device of claim 4, wherein the leading edge of each water deflector comes to a point.

6. The watering device of claim 4, wherein the plurality of water deflectors includes a set of water deflectors having a distal end that is flared outwardly.

7. The watering device of claim 4, wherein the at least one support member includes a plurality of ribs generally radially aligned with the outward direction of water deflected by the deflectors.

8. The watering device of claim 7, wherein each water deflector forms an outwardly directed water stream, and wherein each of the ribs is disposed between adjacent water streams.

9. The watering device of claim 4, wherein the plurality of water deflectors includes from 3 to 12 deflectors.

10. The watering device of claim 4, wherein the plurality of water deflectors includes from 5 to 9 deflectors.

11. The watering device of claim 1, wherein the cover has an open slot that extends from the edge of the cover toward the center of the cover for receiving a plant stem.

12. The watering device of claim 11, wherein the open slot allows the cover to be positioned with a plant stem near the center of the cover.

13. The watering device of claim 1, wherein the water nozzle has an outlet that directs water along the first side of cover.

14. The watering device of claim 1, wherein the cover is generally circular.

15. The watering device of claim 1, wherein the water nozzle comprises a nozzle body having a plug with a terminal end for insertion into a water supply tube, and a water supply groove formed in the plug and longitudinally extending along a side of the plug from the terminal end, wherein the water supply groove branches into a plurality of water distribution grooves, each water distribution groove having an open end for releasing a water stream.

16. The watering device of claim 15, wherein the plurality of water distribution grooves are divergent.

17. The watering device of claim 15, further comprising:
a water supply tube received about the terminal end of the plug.

18. The watering device of claim 15, wherein the plurality of water distribution grooves is formed in a side of the nozzle body.

19. The watering device of claim 15, wherein the plurality of water distribution grooves is formed in the first side of the cover in alignment with the water supply groove in the water nozzle.

20. The watering device of claim 15, wherein the nozzle body has a plurality of plugs, each plug having a terminal end for insertion into a water supply tube and a water supply groove longitudinally extending along a side of the plug from the terminal end, and wherein each water supply groove has a different cross-sectional area for supplying a different amount of water from the water supply tube.

21. The apparatus of claim 20, wherein the nozzle body includes a water shut-off plug having a terminal end for insertion into the water supply tube, wherein the water shut-off plug prevents water flow from the water supply tube.

22. The apparatus of claim 20, wherein each of the plugs are similarly sized for insertion into a common size of water supply tube.

23. The apparatus of claim 22, further comprising:
a water supply tube selectively receivable about the terminal end of any of the plugs.

24. The watering device of claim 20, wherein each water supply groove branches into a plurality of water distribution grooves formed in a side of the nozzle body, wherein each water distribution groove has an open end for releasing a water stream,

25. The watering device of claim 20, wherein the nozzle body is selectively securable to the cover in position the water supply groove of any one of the plurality of plugs in alignment with the plurality of water distribution grooves formed in the first side of the cover.

26. An apparatus, comprising:
a nozzle body having a plug with a terminal end for insertion into a water supply tube; and
a water supply groove formed in the plug and longitudinally extending along a side of the plug from the terminal end, wherein the water supply groove branches into a plurality of water distribution grooves formed in a side of the nozzle body, each water distribution groove having an open end for releasing a water stream.

27. The apparatus of claim 26, wherein the plurality of water distribution grooves are divergent.

28. The apparatus of claim 26, further comprising:
a water supply tube received about the terminal end of the plug

29. An apparatus, comprising:
a nozzle body having a plurality of plugs, each plug having a terminal end for insertion into a water supply tube and a water supply groove longitudinally extending along a side of the plug from the terminal end, wherein each water supply groove branches into a plurality of water distribution grooves formed in a side of the nozzle body, wherein each water distribution groove has an open end for releasing a water stream, and wherein each water supply groove has a different cross-sectional area for supplying a different amount of water from the water supply tube.

30. The apparatus of claim 29, wherein the nozzle body includes a water shut-off plug having a terminal end for insertion into the water supply tube, wherein the water shut-off plug prevents water flow from the water supply tube.

31. The apparatus of claim 29, wherein each of the plugs are similarly sized for insertion into a common size of water supply tube.

32. The apparatus of claim 29, further comprising:
a water supply tube selectively receivable about the terminal end of any of the plugs.
